(19) United States
(12) Patent Application Publication
(10) Pub. No.: US 2011/0184795 A1
(43) Pub. Date: Jul. 28, 2011

(54) Mobile Marketing

(76) Inventor: William Tesch, Grafton, WI (US)

(21) Appl. No.: 13/010,356

(22) Filed: Jan. 20, 2011

Related U.S. Application Data
(60) Provisional application No. 61/297,647, filed on Jan. 22, 2010.

(51) Int. Cl. G06Q 30/00

(52) U.S. Cl. 705/14.16; 705/1.1; 705/319

(57) ABSTRACT

A method for mobile marketing includes, with a mobile computing device, requesting an electronic benefit an entity associated with a mobile marketing system, receiving a first electronic benefit from the entity in response to the request, and receiving a second electronic benefit in response to sharing the first benefit.

### RELATED APPLICATION

The present application claims priority under 35 U.S.C. §119(e) from previous U.S. Provisional Patent Application No. 61/297,647 by William Tesch, entitled “Supersaver.com Mobile Application” filed Jan. 22, 2010, which provisional application is hereby incorporated by reference in its entirety.

### BACKGROUND

Modern cellular phones typically provide a user with a number of features in addition to providing voice communication. These cellular phones are typically referred to as smart phones. Modern smart phones include sophisticated processing systems that provide a user with a number of software applications. Smart phones also include the capability of accessing the internet through connections established between those phones and nearby towers. Access to the internet allows a smart phone to provide a user with typical internet usage applications such as email and web-browsing.

Smart phones also often include locating capabilities. For example, many smart phones are equipped with Global Positioning Satellite (GPS) systems. These systems can determine the smart phone's location with a relatively high degree of accuracy. The combination of locating capabilities and internet access can allow the smart phone to provide a user with applications that can inform the user about various places in close proximity to the user. Marketers desire to make information about their business available to these applications so that the user can receive marketing messages when that user is within close proximity to that business.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a diagram showing an illustrative mobile computing device, according to one example of principles described herein.

FIG. 2 is a diagram showing illustrative elements of a mobile marketing system, according to one example of principles described herein.

FIG. 3 is a diagram showing an illustrative map showing a mobile computing device within range of entities, according to one example of principles described herein.

FIG. 4 is a flow diagram showing an illustrative process for receiving benefits for sharing benefits, according to one example of principles described herein.

FIG. 5 is a flow chart showing an illustrative method for mobile marketing, according to one example of principles described herein.

Throughout the drawings, identical reference numbers designate similar, but not necessarily identical, elements.

### DETAILED DESCRIPTION

The present specification discloses a method for mobile marketing that incentivizes customers to participate in the marketing process. According to certain illustrative examples, a user may use a mobile marketing application associated with a mobile marketing system on his or her mobile computing device such as a smart phone. Through this application, a user can view a number of entities such as businesses who are associated with the mobile marketing system. In some cases, the user can search for businesses within a specified geographic region. The user may then request electronic benefits from one of the available entities. In response, that business entity may send an electronic benefit to that mobile computing device via the mobile marketing application. The electronic benefit may be a coupon, reward point, or other such deal or benefit that provides the user with a discount on a good such as a product or service offered by the entity. Thus, the electronic benefit acts as a marketing tool for various entities providing those electronic benefits.

Upon receiving that electronic benefit, the user may share that benefit with his or her contacts. This sharing may be done through email, text messaging, or various social networking applications provided to the user by the smart phone. The mobile computing device may then inform the entity that the electronic benefit has been shared with others. In return, the entity can then send additional electronic benefits to the user. Thus, the user receives benefits for forwarding marketing tools to others and is therefore incentivized to do so.

Through use of methods and systems described herein, users may be made aware of retailers and other businesses nearby that are willing to make offers to that user. Furthermore, the user will be motivated to forward those offers to others. Thus, the system is beneficial to users because it provides them with more benefits and it is beneficial to businesses because they are able to market to more individuals.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

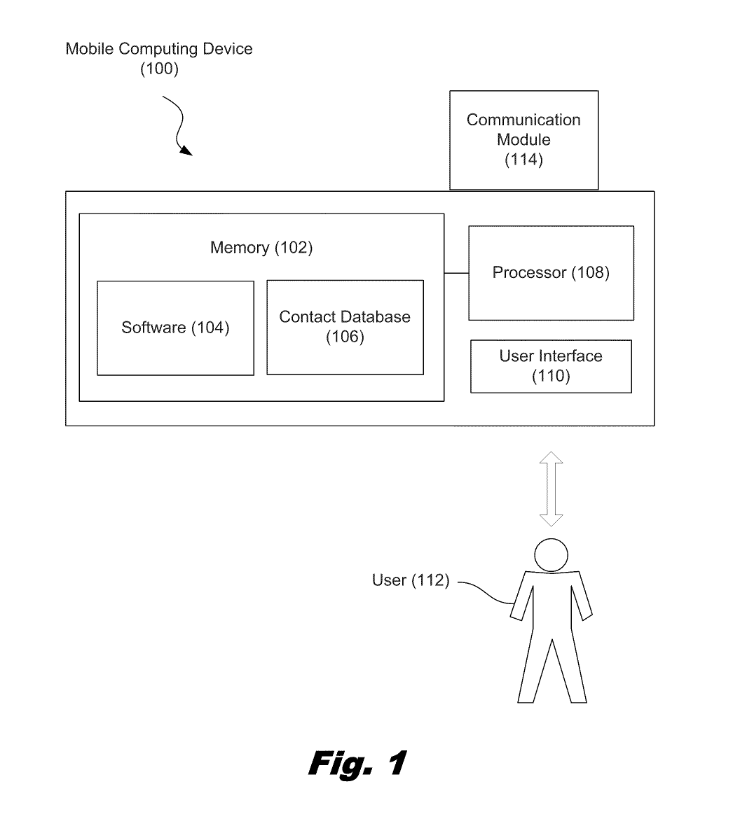

Referring now to the figures, FIG. 1 is a diagram showing an illustrative mobile computing device (100) such as a cell or mobile phone. According to certain illustrative examples, the mobile computing device (100) may include a memory (102) having software (104) and data (106) stored thereon.

There are many types of memory available. Some types of memory, such as solid state drives, are designed for storage. These types of memory typically have large storage volume but relatively slow performance. Other types of memory, such as those used for Random Access Memory (RAM), are optimized for speed and are often referred to as “working memory.” The various forms of memory may store information in the form of software (104) and data (106).

The mobile computing system (100) also includes a processor (108) for executing the software (104) and using or updating the data (106) in the memory (102). The software (104) may include an operating system. An operating system allows other applications to interact properly with the hardware of the mobile computing system. The other applications may include social networking applications as well as applications for using email and other communication methods.

A user interface (110) may provide a means for the user (112) to interact with the computing system (100). The user interface may include any collection of devices for interfacing with a human user (112). For example, the user interface (110) may be a touch-screen device that acts both as a display and as an input.

The mobile computing device also includes a communication module (114). The communication module (114) provides the hardware and software that allows the mobile computing device to communicate with external equipment such as a cell-phone tower through radio waves or another communication device in close proximity through infrared signals.

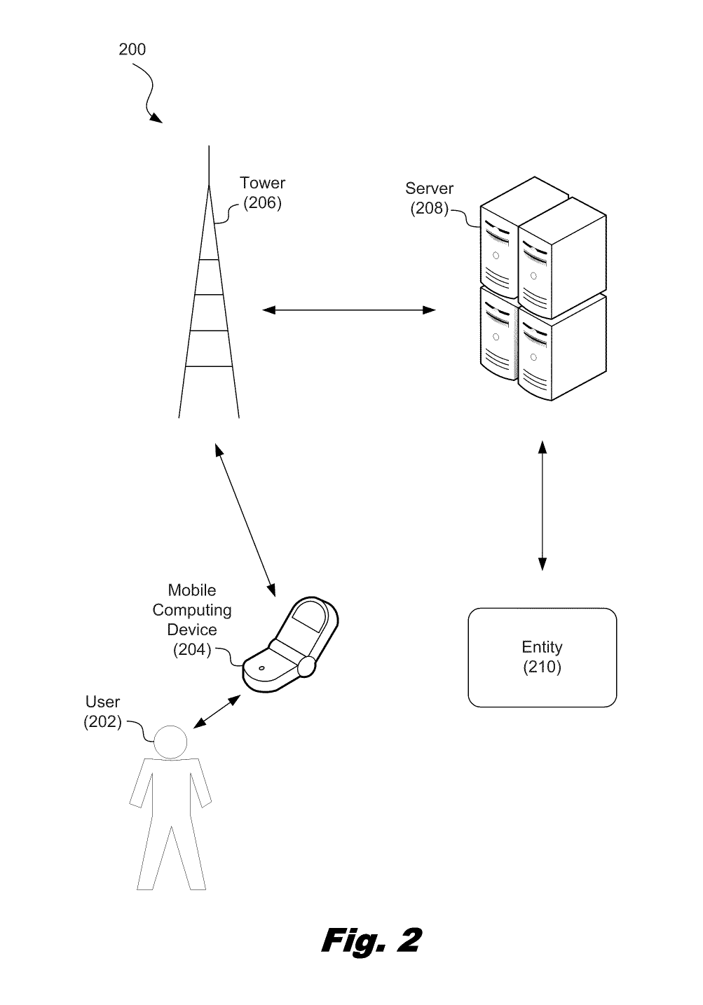

FIG. 2 is a diagram showing illustrative elements (200) of a mobile marketing system. According to certain illustrative examples, a user (202) may receive electronic benefits from businesses on his or her mobile computing device (204). In some cases, the user may view entities associated with the mobile marketing system within a specified geographic range. This geographic range may be a certain distance within the user's current location. This will allow the user to see nearby physical locations associated with the business entities associated with the mobile marketing system.

A user (202) may receive such messages by registering his or her mobile computing device (202) with a server (208) associated with the mobile marketing system. Business entities (210) may also access the server (208) to make offers and provide electronic benefits to users who have opted to receive such offers and benefits. This registration may be done either through the mobile computing device (204) itself or another computing device communicatively coupled to the sever (208). The server may be communicatively coupled to a cell-phone tower (206) which is in turn connected to mobile computing devices within range of that tower (206).

In one example, a particular entity (210), such as a restaurant, may access the server system (202) that is associated with the mobile marketing system. The restaurant may then provide to the server system (208), electronic benefits to be received by users interested in doing business at that restaurant. These electronic benefits may be, for example, a discount on a meal or a buy one, get one free offer. When a user (202) who is carrying his or her mobile computing device (204) goes to that restaurant, he or she may present the appropriate electronic benefits from that restaurant with the mobile device. These benefits may be received through email, text message, or a unique messaging system associated with the mobile marketing application running on the mobile computing device (204).

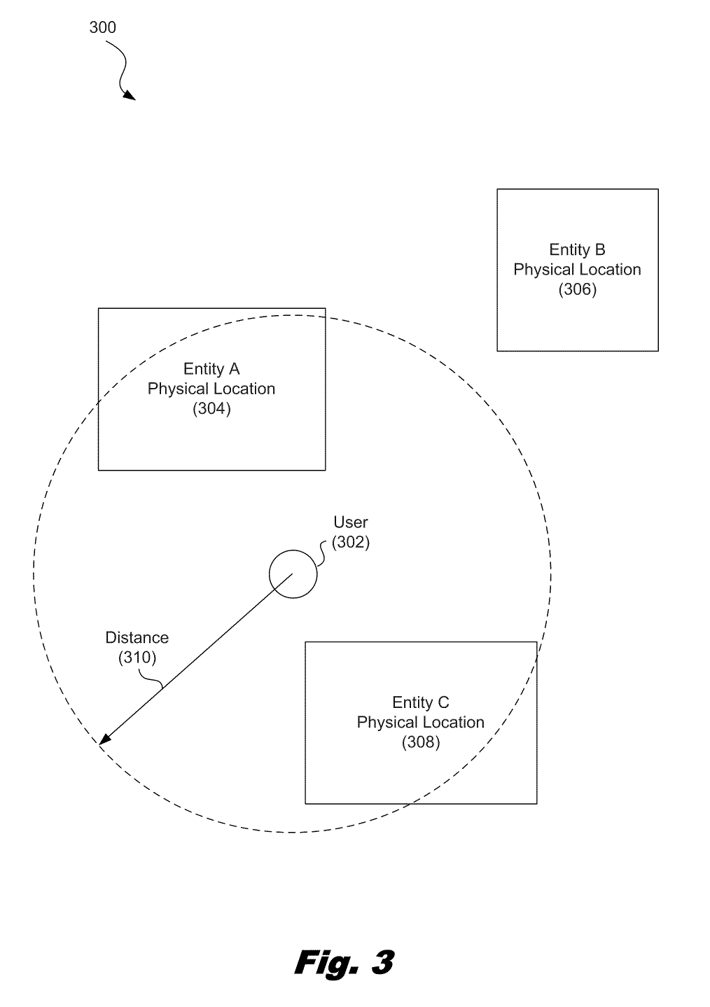

FIG. 3 is a diagram showing an illustrative map (300) showing a user (302) with a mobile computing device and a number of entities within a specified distance from the mobile computing device. According to certain illustrative examples, a user (302) may be traveling and wish to know which, if any, business entities nearby are providing benefits through the mobile marketing system. The user can then use the mobile marketing application on his or her mobile computing device and see what entities are within a specified distance (310).

In the example shown in FIG. 3, the user (302) is currently within the specified distance (310) of the physical location (304) associated with entity A and the physical location (308) associated with entity C. Thus, the mobile computing device may display entity A and entity C to the user (302). The user may then request electronic benefits from either entity A or entity C. The user is not, however, within range of the physical location (306) associated with entity B. Thus, the mobile computing device will not display entity B to the user (302) unless the user specifies a greater distance (310).

The user (302) does not have to be within the range of such entities to request electronic benefits. For example, the user may, from his or her home, search through all of the entities available through the mobile marketing system and request electronic benefits from selected businesses.

A user's position may be determined through use of a locator mechanism. One such mechanism is a GPS system. As mentioned above, many mobile computing devices are equipped with GPS technology. GPS technology uses signals received from satellites orbiting the earth to triangulate a user's position on the surface of the earth.

Another triangulation method for determining a user's position is to measure the signal strength received from the mobile computing device by the nearest towers. For example, a particular mobile computing device will produce a signal that is received by nearby towers. The strength of the signal received at those towers is dependent upon the distance from those towers. Thus, the user's position can be triangulated by determining the signal strength from the mobile computing device at three towers. Although slightly less accurate than a GPS system, this method is sufficient to determine whether the mobile computing device is close to a physical location associated with an entity that is providing electronic benefits.

These locator mechanisms may not determine the user's precise location. For example, these locating methods may only determine the user's location within 100 meters. However, this is adequate for the purpose of showing the user what business entities are within a specified range. Typically, a user may indicate a much larger distance than 100 meters. For example, the user might search for business entities within a 3 mile range.

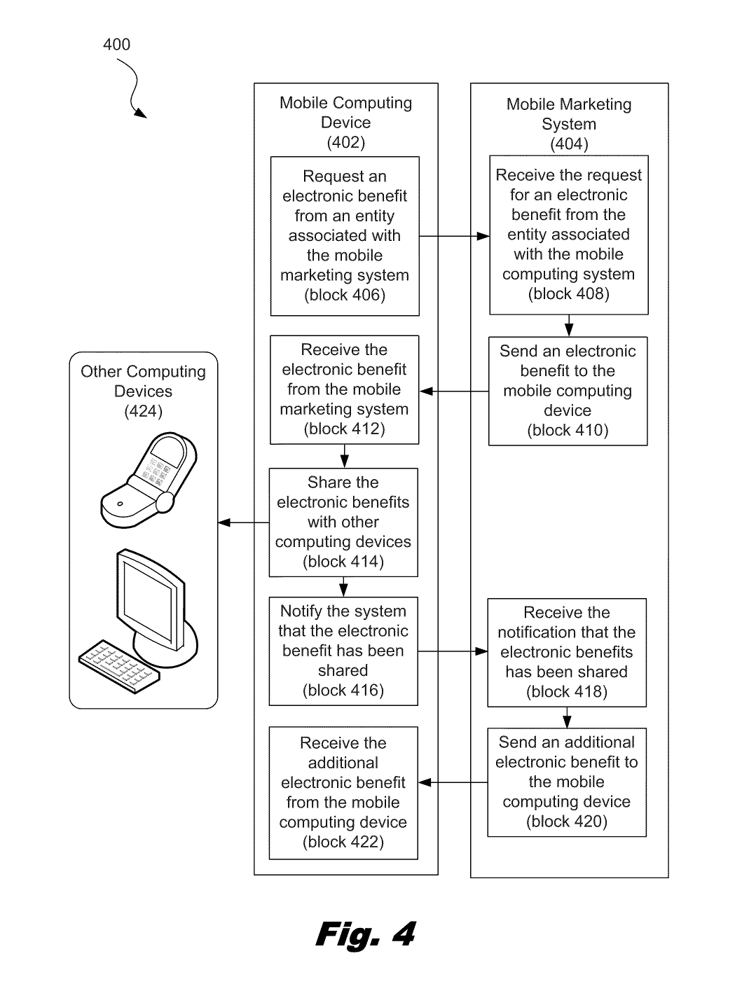

FIG. 4 is a flow diagram showing an illustrative process for receiving benefits for sharing benefits. According to certain illustrative examples, the process starts when a user requests (block 406), using his or her mobile computing device (402), an electronic benefit from an entity associated with the mobile marketing system (404).

The mobile marketing system (404) can be a service that is available over the internet. Entity's that wish to provide benefits to users through the mobile marketing system may access this service to indicate what offers and benefits should be provided to customers coming into close proximity with the entity's physical location. Furthermore, users who wish to receive such benefits may register their mobile computing devices with the mobile marketing system (404). The mobile marketing system (404) may use its own software application that may be designed to be run particular types of mobile computing devices.

After the mobile marketing system (404) receives (block 408) the request for an electronic benefit from an entity associated with the mobile marketing system, then the mobile marketing system (404) can send (block 410) an appropriate electronic benefit to the user on his or her mobile computing device (402). This electronic benefit may be a coupon, an announcement of a sale, or a number of reward points, etc. In some cases, the first electronic benefit may simply be an advertisement for a particular product.

In some cases, the notification to the mobile computing system (402) may be done automatically when the user selects a business or particular entity on the mobile application. Alternatively, a user may manually indicate to an entity though the mobile marketing system (404) that he or she is within range of a particular entity. For example, a user may walk into a particular retail store. The user may then use his or her mobile computing device (402) to indicate to the retailer, through the mobile marketing system, that he or she is actually at the retailer store. This indicates to the mobile marketing system (404) that he or she desires to receive any benefits offered by that retail store. If that retailer offers benefits through the mobile marketing system (404), then the user may receive such benefits in response to checking in. The mobile marketing system (404) may or may not confirm that the user is in fact at the retail store. If a confirmation is required by the retailer, then the confirmation may be performed through use of a locator mechanism such as a GPS system.

After the user receives (block 412) the first electronic benefit from the mobile marketing system (404) as arranged by the entity, he or she may share (block 414) that first benefit to any of his or her contacts. The electronic benefit may be shared by forwarding a copy of the electronic benefit to other computing devices (424) such as other mobile computing devices or desktop computing systems that can be accessed by other individuals. The electronic benefit may be forwarded through email or a text message. Alternatively, the electronic benefit may be forwarded to a user's friends through a social networking application such as Facebook or Twitter. These types of applications can typically be accessed through a user's mobile computing device (402).

After sharing the electronic benefits with others, the user's mobile computing device may notify (block 416) the mobile marketing system (404) that he or she has shared the electronic benefit. After receiving (block 418) the notification that the electronic benefits have been shared, the mobile marketing system (404) can send (block 420) additional electronic benefits to the user's mobile computing device (402). The user may then receive (block 422) these benefits on his or her mobile computing device (402) and then redeem those benefits in a manner indicated by the entity.

For example, the electronic benefit maybe a coupon with a particular barcode for an entity such as a music retailer. The user can then take his or her mobile computing device to the music retailer and have them scan the barcode displayed on the screen of the user's mobile computing device. The retailer may then discount a purchase made by the user according to the coupon that was received as an electronic benefit.

The entity may have complete control over what benefits to provide to users. Based on the entity's marketing strategies, the entity may choose a set of benefits or offers to be made as first benefits. Additionally, the entity may choose a further set of benefits to be received by users as a reward for sharing their first received benefits. In some cases, an entity may offer cumulative benefits. That is, a user will receive more additional benefits for sharing a first benefit with more people.

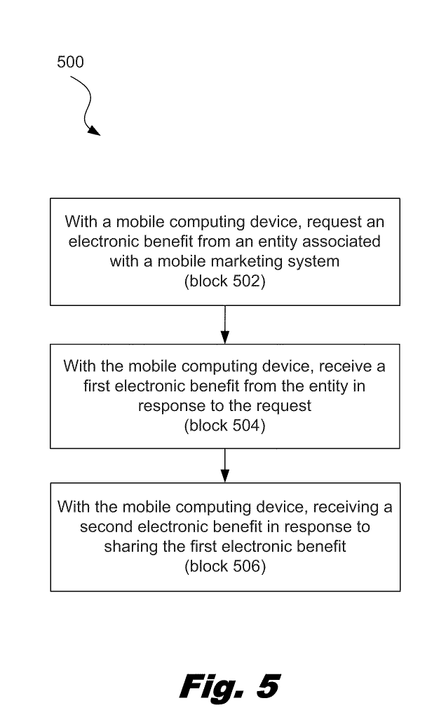

FIG. 5 is a flow chart showing an illustrative method for mobile marketing. According to certain illustrative examples, the method includes, with a mobile computing device, requesting (block 502) an electronic benefit an entity associated with a mobile marketing system, with the rnobile computing device, receiving (block 504) a first electronic benefit from the entity in response to the request, and with the mobile computing device, receiving (block 506) a second electronic benefit in response to sharing the first benefit.

In conclusion, through use of methods and systems described herein, users may be made aware of retailers and other businesses nearby that are willing to make offers to that user. Furthermore, the user will be motivated to forward any offers received from those retailers or businesses to others. Thus, the system is beneficial to users because it provides them with more benefits and it is beneficial to businesses because they are able to market to more individuals.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method for mobile marketing, the method comprising:
with a mobile computing device, requesting an electronic benefit from an entity associated with a mobile marketing system;
with said mobile computing device, receiving a first electronic benefit from said entity in response to said request; and
with said mobile computing device, receiving a second electronic benefit in response to sharing said first benefit.

2. The method of claim 1, further comprising, with said mobile computing system; displaying to a user; a number of entity's within a specified geographic area, said entity's associated with said mobile marketing system.

3. The method of claim 1, further comprising confirming that said mobile computing device is within a distance of said physical location by using a locator mechanism associated with said mobile computing device.

4. The method of claim 3, wherein said locator mechanism comprises at least one of a Global Positioning System (GPS) and a tower triangulation method.

5. The method of claim 1, wherein sharing said first benefit comprises, with said mobile computing system, forwarding a copy of said benefit to at least one other computing device.

6. The method of claim 5, wherein forwarding said copy of said benefit is done through at least one of: an email, a text message, and an electronic message associated with a mobile marketing system.

7. The method of claim 5, wherein forwarding said copy of said benefit is done through an interface to a social networking application.

8. The method of claim 1, wherein said benefit comprises a discount on a good offered by said entity.

9. The method of claim 1, wherein said benefit comprises a reward point towards a good offered by said entity.

10. The method of claim 1, further comprising, with said mobile computing device:
sending a request to a server system, said server system storing information related to physical locations associated with additional entities within a distance from said mobile computing device, said additional entities having access to said server system; and
receiving an offer from one of said additional entities.

11. A computing device comprising:
a processor; and
a memory communicatively coupled to said processor;
in which said processor is configured to:
request an electronic benefit from an entity associated with a mobile marketing system;
receive a first electronic benefit from said entity in response to said request; and
receive a second electronic benefit in response to sharing said first electronic benefit.

12. The method of claim 11, wherein said processor is further configured to displaying to a user, a number of entities within a specified geographic area, said entity's associated with said mobile marketing system.

13. The method of claim 12, wherein said processor is further configured to confirm that said mobile computing device is within said distance of said physical location by using a locator mechanism associated with said mobile computing device.

14. The method of claim 13, wherein said locator mechanism comprises at least one of a Global Positioning System (GPS) and a tower triangulation system.

15. The method of claim 11, wherein to share said first benefit, said processor is further configured to forward a copy of said benefit to at least one other computing device.

16. The method of claim 15, wherein to forward said copy of said benefit is done through at least one of: an email, a text message and an electronic message associated with a mobile marketing system.

17. The method of claim 15, wherein to forward said copy of said benefit is done through an interface to a social networking application.

18. The method of claim 11, wherein said benefit comprises a discount on a good offered by said entity.

19. The method of claim 11, wherein said benefit comprises a reward point towards a good offered by said entity.

20. A method for incentivizing mobile marketing, the method comprising:
with said mobile computing device, requesting a first electronic benefit from an entity within a specified geographic range, said entity being associated with a mobile marketing system;
with said mobile computing device, receiving a first electronic benefit;
with said mobile computing device, forwarding a copy of said first electronic benefit to an alternate computing device;
with said mobile computing device, reporting said forwarding to said entity; and
with said mobile computing device, receiving a second electronic benefit from said entity in response to said reporting.
